(19) United States
(12) Patent Application Publication
(10) Pub. No.: US 2005/0238309 A1
(43) Pub. Date: Oct. 27, 2005

(54) Optical fibers for use in harsh environments

(76) Inventors: Gary Drenzek, Westfield, MA (US); Kanxian Wei, Shrewsbury, MA (US); Musa Awaleh, South Windsor, CT (US); Imtiaz Majid, Shrewsbury, MA (US)

Correspondence Address: GOODWIN PROCTER LLP;PATENT ADMINISTRATOR, EXCHANGE PLACE, BOSTON, MA, 02109-2881, US

(21) Appl. No.: 11/110,577

(22) Filed: Apr. 20, 2005

Related U.S. Application Data
(60) Provisional application No. 60/564,263, filed on Apr. 21, 2004.

(51) Int. Cl. G02B 6/22

(52) U.S. Cl. 385/128

(57) ABSTRACT

An optical fiber includes a glass fiber having a glass core and a cladding, and a hermetic layer having a high thermal stability disposed on the cladding. The glass core contains not more than about 1 mole % phosphorous. The optical fiber is adapted to operate under harsh conditions, such as elevated temperatures and/or hydrogen-containing environments. Methods for producing optical fibers, as well as methods for transmitting radiation in harsh environments using the optical fibers, are also provided.

### CROSS-REFERENCE TO RELATED APPLICATION

This application claims priority to, and the benefits of, U.S. Provisional Application Ser. No. 60/564,263, filed on Apr. 21, 2004, the entire disclosure of which is hereby incorporated by reference.

### FIELD OF THE INVENTION

This invention relates to the field of optical fibers, more particularly to optical fibers adapted for use in harsh environments.

### BACKGROUND

Optical fibers increasingly find application in environments that are relatively harsh compared to traditional telecommunications operating conditions. For example, in geophysical and geothermal applications (e.g., oil and energy exploration), optical fibers are deployed in very diverse roles ranging from data logging (requiring high bandwidth fiber) to acting as distributed temperature and pressure sensing elements. The environment that the optical fiber experiences in such applications can reach temperatures as high as several hundred degrees Celsius and pressures of several hundred atmospheres in gaseous/liquid environments that contain water, hydrogen, hydrocarbons, sulfides, etc. It is well known that traditional glass optical fibers are very susceptible to both hydrogen and moisture ingress, and therefore the use of optical fibers in such environments generally requires protection from these compounds in order to ensure proper function over extended periods of time.

Silica-based optical fibers, made by vapor technologies such as modified chemical vapor deposition (MCVD), vapor-phase axial deposition (VAD), and outside vapor deposition (OVD), typically consist of a silica cladding surrounding a doped core with higher refractive index. Germanium dioxide (GeO₂) and phosphorous pentoxide (P₂O₅) are typically used to increase the refractive index of the core. P₂O₅ has the added benefit of reducing the deposition temperature, making it practical for large-core, long process-time fibers such as multi-mode fibers. For example, for the MCVD process, it is customary to incorporate small amounts of phosphorus, such as P₂O₅, during the core deposition (or the barrier deposition in the manufacture of single-mode fiber preforms) to soften the glass and simplify the preform collapse process, which is the final step in the preform manufacture. U.S. Pat. No. 4,339,173 describes the benefits of P₂O₅ in MCVD multi-mode fiber fabrication.

We have discovered, however, that P₂O₅ also catalyzes the reaction of hydrogen with defects in the glass to form harmful silicon-hydroxide (Si—OH) and, in fibers doped with germanium, germanium-hydroxide (Ge—OH) bonds, especially at elevated temperatures (i.e., greater than 100° C.). At temperatures below 200° C., the reaction of germanium with H₂ is negligible in the absence of P₂O₅; however, even in the presence of small amounts of phosphorus, the Ge—OH bond forming reaction is accelerated at temperatures as low as 100° C. The precise mechanism by which the reaction occurs is not fully understood; it is known, however, that the formation of Ge—OH bonds can compromise the performance of optical fibers. For example, in a standard multi-mode fiber, the region of the spectrum that is adversely affected by the formation of Ge—OH bonds ranges from approximately 1350 to 1650 nm; because this is also the low loss window for silica fiber, it corresponds to the region of interest for distributed temperature sensing in a large fraction of sensing systems employing silica fibers.

The traditional approach to protecting optical fibers from harsh environments, including hydrogen-containing atmospheres, has been the application of an impervious coating on the surface of the glass. Many different coatings have been tried, including metals (see, e.g., Wysocki, “Reduction in Static fatigue of Silica Fibers by Hermetic Jacketing,” Applied Physics Letters 34(1) (January 1979)), ceramics (see, e.g., U.S. Pat. Nos. 4,028,080 and 4,512,629) and carbon (see, e.g., U.S. Pat. No. 4,183,621 and Huff et al., “Amorphous Carbon Hermetically Coated Optical Fibers,” Technical Digest for Optical Fiber Communication Conference, Paper TUG-2 (1988)). These coatings can protect the glass core from hydrogen and moisture ingress, at least at relatively low temperatures (i.e., not exceeding 100° C.). At elevated temperatures, however, hermeticity with respect to hydrogen ingression can start to degrade. For example, at temperatures of 100° C. or below, the saturation lifetime of a carbon-coated fiber with respect to hydrogen ingress is on the order of years. At temperatures above 150° C., however, saturation is achieved much faster. See, e.g., LeMaire et al., “Hydrogen permeation in optical fibers with hermetic carbon coatings,” Electron Lett. 24:1323-1324 (1988)).

There is therefore a need for an optical fiber that can withstand prolonged exposure to harsh environments, including elevated temperatures and hydrogen-containing atmospheres.

### SUMMARY OF THE INVENTION

The present invention provides an optical fiber having a glass core that contains not more than about 1 mole % phosphorous, preferably about 0 mole % phosphorous, and, surrounding the fiber, a hermetic layer preventing ingress of hydrogen and desirably exhibiting a high thermal stability. In general, the core is immediately surrounded by one or more cladding layers, which underlie the hermetic layer. This approach reduces the incidence of performance-degrading impurities in the glass core by (i) providing a barrier to hydrogen ingress, as noted, and (ii) minimizing the reaction between hydrogen and the glass. The glass core can be silica doped with germanium.

In certain embodiments, the cladding contains not more than about 1 mole % phosphorous, preferably about 0 mole % phosphorous. In other embodiments, the cladding contains more than about 1 mole % phosphorous, but desirably in a region well away from the core so as not to interfere with light propagation; the objective in this case is to trap hydrogen before it reaches the core. The hermetic layer can contain ceramics, metals, carbon, or combinations thereof. Some embodiments include an outer layer disposed on the hermetic layer. The outer layer can include, for example, a polymer (e.g., acrylate polymers, fluorinated polymers, phenolic polymers, or polyimide polymers), or a metal (e.g., aluminum, gold, nickel, tin, or alloys thereof).

The invention also provides a method of making an optical fiber according to the invention that includes applying a hermetic layer to a glass fiber having a glass core and a cladding, where the glass core contains not more than about 1 mole % phosphorous.

The invention further provides a method of transmitting radiation in a harsh environment using an optical fiber according to the invention. A hermetic layer is disposed over a glass fiber that includes a glass core and a cladding. The glass core contains not more than about 1 mole % phosphorous. The resulting optical fiber is deployed in a hydrogen-containing environment having a temperature in excess of 100° C., or in excess of 200° C. Radiation is then transmitted through the optical fiber.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a cross-sectional view of an optical fiber according to an embodiment of the invention.

FIG. 2 is a side view of the optical fiber of FIG. 1.

FIG. 3 is a cross-sectional view of an optical fiber according to another embodiment of the invention.

FIG. 4 is a schematic diagram of an apparatus for measuring spectral attenuation of optical fibers according to the invention.

FIG. 5 is a graphical representation of the spectral attenuation of optical fibers with glass cores having 1.3 mol %, 1.1 mol %, and 0.6 mol % P₂O₅ according to the invention at elevated temperature and pressure.

FIG. 6 is a graphical representation of the spectral attenuation of optical fibers with glass cores having 1.3 mol %, 1.1 mol %, and 0.6 mol % P₂O₅ according to the invention at a different temperature and pressure.

FIG. 7 is a graphical representation of the spectral attenuation of optical fibers with glass cores having 0.6 mol % and 0 mol % P₂O₅ according to the invention at elevated temperature and pressure.

### DETAILED DESCRIPTION

The present invention provides an optical fiber that exhibits improved resistance to harsh environments. Specifically, the fiber includes a glass fiber having a glass core that contains not more than 1 mole % (and ideally about 0 mole %) phosphorous, which minimizes the reaction between ingressing hydrogen and the glass core. The fiber also includes a hermetic layer disposed on the glass fiber, which inhibits hydrogen ingress into the glass core. The present invention also provides methods for making optical fibers that exhibit improved resistance to harsh environments, as well as methods for transmitting radiation in harsh environments using the optical fibers.

1. Optical Fiber

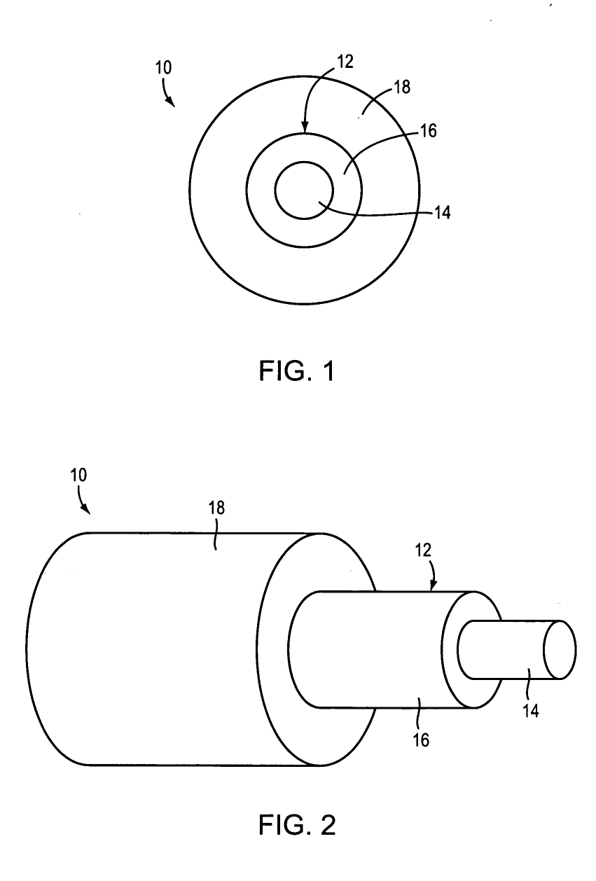

FIGS. 1 and 2 illustrate an optical fiber according to the present invention. The optical fiber 10 includes a glass fiber 12, which typically comprises a core 14 and a cladding 16. Disposed over the cladding 16 is at least one hermetic layer 18. FIGS. 1 and 2 illustrate an optical fiber that contains only a single hermetic layer; however, optical fibers according to the invention may contain more than one hermetic layer.

In the illustrated embodiment, the core 14 of the glass fiber 12 is the region where light is substantially confined during its propagation along the length of the optical fiber 10. The core 14 is typically made of silica-based glass that can be doped with other materials to modify its refractive index. The refractive index of the core 14 can be substantially constant throughout, or it can vary, for example, by gradually changing as a function of radial distance from the center of the core 14. The dopant can be present in about 3 mole % to about 30 mole %. Suitable dopants include germanium compounds (e.g., germanium oxide (GeO₂)), phosphorous compounds (e.g., phosphorous pentoxide (P₂O₅), desirably present at a level no greater than 1 mole %), fluorine, rare earths, TiO₂, B₂O₃, and Al₂O₃. In a particular embodiment, the core includes a germanium dopant.

The phosphorous content of the core 14 does not exceed about 1 mole %, and preferably is about 0 mole %. Phosphorous-containing dopants such as P₂O₅ can be present in the core 14, but not in amounts that exceed about 1 mole % phosphorous. By minimizing the phosphorous content of the core 14, the reaction between ingressing hydrogen and the glass core 14 is minimized, leading to a reduction in hydroxyl species that induce bond formation (e.g., Si—OH and/or Ge—OH bond formation).

The cladding 16 completely surrounds the core 14 and acts to direct the path of the light along the core 14 and prevent light from leaking out of the core 14. The cladding 16 is typically made of silica-based glass and can be doped with other materials to modify its refractive index. Generally, the refractive index of the cladding 16 is lower than the refractive index of the core 14. The refractive index of the glass fiber 12 can undergo an abrupt change at the boundary between the core 14 and the cladding 16 (i.e., a step-index fiber), or the refractive index of the glass fiber 12 can vary gradually as a function of radial distance from the center of the glass fiber (i.e., a graded-index fiber). Suitable dopants for increasing the refractive index of the cladding 16 include GeO₂, P₂O₅, TiO₂, B₂O₃, Al₂O₃, and rare earths, while suitable dopants for decreasing the refractive index include fluorine and B₂O₃.

In some embodiments, the cladding 16 contains not more than about 1 mole % phosphorous, preferably about 0 mole % phosphorous. In these embodiments, phosphorous-containing dopants such as P₂O₅ can be present in the cladding 16, but not in amounts that exceed about 1 mole % phosphorous. In other embodiments, the cladding 16 is doped with phosphorous in order to react with ingressing hydrogen before it reaches the core 14. In these embodiments, the phosphorous dopant may be uniformly distributed within the cladding 16, or the phosphorous dopant may be non-uniformly distributed (e.g., the phosphorous dopant may be concentrated in the portions of the cladding 16 that are adjacent or close to the hermetic layer 18, while the portions of the cladding 16 that are adjacent or close to the core 14 contain little or no phosphorous dopant).

The hermetic layer 18 serves to preserve the strength of the glass fiber 12 and to preserve its optical properties by inhibiting ingression of compounds such as water and/or hydrogen. The hermetic layer 18 is made from a material that is resistant to ingress of water and gases, such as hydrogen, and desirably has a high thermal stability. Suitable materials for a hermetic layer 18 include ceramics, metals (e.g., aluminum, gold, nickel, tin, and alloys thereof), carbon, and combinations thereof. In particular embodiments, the hermetic layer 18 comprises carbon.

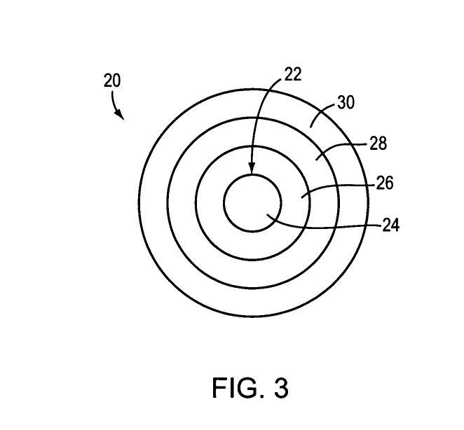

FIG. 3 illustrates another embodiment of an optical fiber 20 that includes a glass fiber 22 comprising a core 24 and a cladding 26, at least one hermetic layer 28 disposed over the cladding 26, and an outer layer 30 disposed over the hermetic layer 28. The outer layer 30 serves to protect the glass fiber 22 from damage and to preserve its tensile strength. The outer layer 30 is typically made from a material that is resistant to air and water and is able to withstand prolonged exposure to heat. Suitable materials for an outer layer 20 include polymers, such as polyimide polymers, fluorinated polymers (e.g., PFA and/or FEP), phenolic polymers, and polyetheretherketone (PEEK). The outer layer 30 can also consist of or include a metal, such as aluminum, gold, nickel, tin, or alloys thereof. In a particular embodiment, the outer layer 30 includes a polyimide polymer. FIG. 3 illustrates an optical fiber that contains only a single outer layer; however, optical fibers according to the invention may contain more than one outer layer.

2. Making an Optical Fiber

The manufacture of glass fibers is well known in the art. In general, glass fibers are drawn from a glass preform, which can be manufactured using a variety of processes, including modified chemical vapor deposition (MCVD), vapor-phase axial deposition (VAD), and outside vapor deposition (OVD), for example. The preforms according to the present invention include not more than about 1 mole % phosphorous, preferably about 0 mole % phosphorous. The preform is fed into a furnace at a controlled rate, and the glass fiber is drawn from the molten end of the preform. Single mode glass fibers, which transmit only one ray of light, have a small core diameter (<10 μm), while multi-mode fibers typically have larger cores that can guide many modes simultaneously. Both single- and multi-mode fibers can be fabricated according to the methods of the present invention.

The hermetic layer is applied to the glass fiber after it has been drawn from the preform. The hermetic layer can be applied using any method known in the art, such as by spraying, chemical vapor deposition, vacuum deposition (e.g., sputtering), pulling the fiber through a pool of liquid, passing the fiber over a moistened wick, and pulling the fiber through a coating die, for example. The hermetic material can also be melted, applied to the fiber in a molten state, and allowed to solidify or cure.

Hermetic layers comprising carbon can be applied to the glass fiber in a variety of ways. For example, the glass fiber can be drawn into a suspension of colloidal carbon particles in a solvent such as alcohol or water, and then heated to form the carbon layer on the glass surface. Other methods such as plasma coating, chemical vapor deposition, or vacuum deposition can also be used. In addition, other forms of graphite-like materials based on carbon or hydrocarbons can be employed. For example, a hermetic layer can be applied to a glass fiber by pyrolyzing a hydrocarbon, such as methane, in a reducing or inert atmosphere.

After application of the hermetic layer, one or more outer layers may be applied. Any of the techniques described above can also be used to apply the outer layers. In a particular embodiment, an outer layer is applied by moving the fiber through a coating die followed by heat curing.

3. Transmitting Radiation

Optical fibers according to the invention are designed to withstand prolonged exposure to harsh environmental conditions with minimal effect on their ability to transmit radiation. For example, the optical fibers can be adapted to operate at elevated temperatures (e.g., in excess of 100° C., or in excess of 200° C.), elevated pressures (e.g., in excess of 100 atm), and/or in gaseous/liquid environments that contain, for example, water, hydrogen, hydrocarbons, and/or sulfides. In a particular embodiment, the optical fiber is adapted for use in a hydrogen-containing environment. The optical fibers can be deployed in diverse roles, including, for example, data logging and acting as distributed temperature and/or pressure sensing elements. Optical fibers according to the present invention can be used with any system or device that utilizes optical fibers, as recognized by one of skill in the art.

### 4. EXAMPLES

### Example 1

To test the impact of the phosphorous content of the glass core on the performance of optical fibers, three graded-index multimode (50/125 μm, 0.2 NA) optical fibers were constructed containing P₂O₅-doped silica cores surrounded by a silica cladding, a carbon hermetic layer, and a polyimide outer layer according to the methods of the invention. The core of each fiber contained different mole percentages of P₂O₅, as shown in Table 1.

| | P₂O₅ content |
|---|---|
| Fiber | (mol %) |
| 1 | 1.3 |
| 2 | 1.1 |
| 3 | 0.6 |

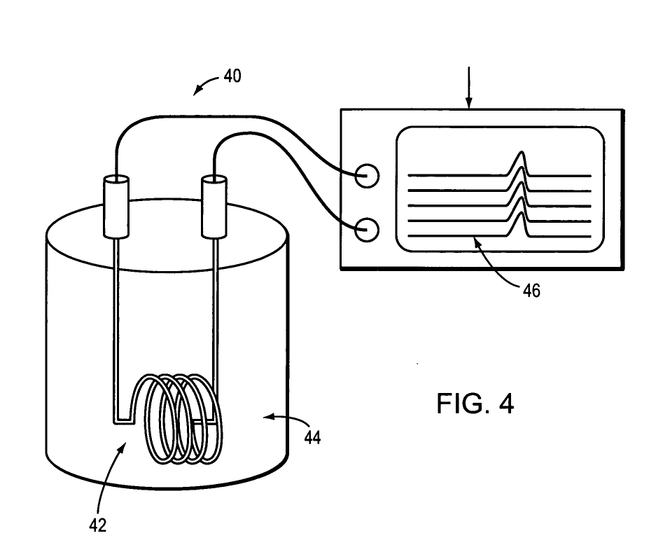

The optical performance of each fiber was tested as follows. Referring to FIG. 4, a length of an optical fiber 40 was shaped into coils 44 having a diameter of about 5 inches. The coils 42 were placed in an autoclave 44, and the ends of the optical fiber 40 were connected to an optical spectrum analyzer 46, which sends discrete wavelengths of light through one end of the optical fiber 40 and measures the light output that is transmitted through the other end of the optical fiber 40. The spectral attenuation of the light passing through the optical fiber 40 is recorded and expressed in decibels/kilometer (dB/km).

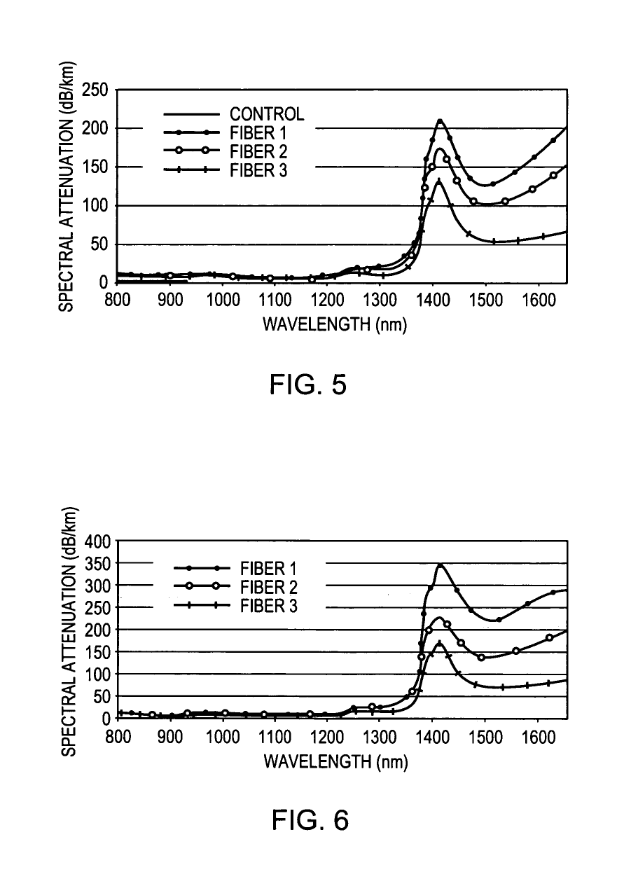

As a control, the spectral attenuation of Fiber 1 was measured at ambient temperature and atmosphere. Wavelengths of light between about 800 nm and about 1650 nm were passed through the fiber and the spectral attenuation was measured, as shown in FIG. 5.

Next, the hydrogen pressure of the autoclave was increased to 1700 pounds/square inch (psi) and the temperature increased to 185° C. After 44 hours under these conditions, the same wavelengths of light were passed through Fiber 1 and the spectral attenuation was measured. The same procedure was repeated with Fiber 2 and Fiber 3. The results of the experiments are represented graphically in FIG. 5. As FIG. 5 illustrates, optical fibers exhibit hydrogen-induced spectral attenuation at elevated temperature and pressure, particularly at wavelengths greater than 1350. However, the attenuation decreases as the amount of P₂O₅ in the glass core decreases.

### Example 2

Three optical fibers having glass cores with the same P₂O₅ content as those in Table 1 were fabricated according to the invention. The procedure of Example 1 was repeated for each fiber, except that each fiber was held at 1600 psi of hydrogen and 200° C. for 22 hours prior to measuring spectral attenuation. The results of the experiments are represented graphically in FIG. 6, and confirm that hydrogen-induced spectral attenuation of optical fibers at elevated temperature and pressure decreases as the amount of P₂O₅ in the glass core decreases.

### Example 3

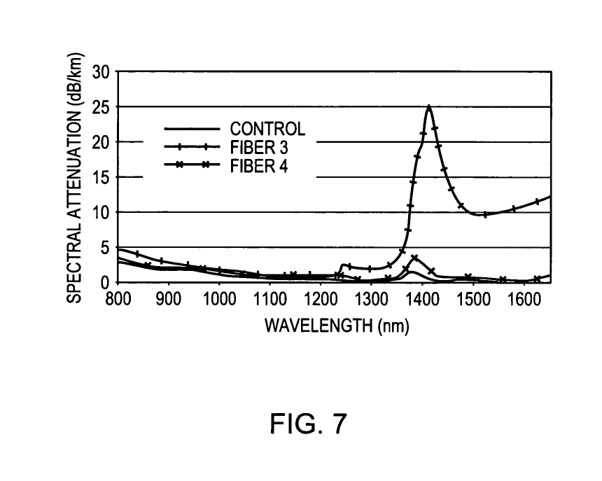

Optical fibers having glass cores with 0.6 mol % P₂O₅ (Fiber 3) and 0 mol % P₂O₅ (Fiber 4) were fabricated according to the invention. As a control, the spectral attenuation of Fiber 3 was measured at ambient temperature and atmosphere. Next, the hydrogen pressure of the autoclave was increased to 1500 psi and the temperature increased to 185° C. After 19 hours under these conditions, the same wavelengths of light were passed through Fiber 3 and the spectral attenuation was measured. The same procedure was repeated with Fiber 4. The results of the experiments are represented graphically in FIG. 7, which shows that hydrogen-induced spectral attenuation diminishes as the phosphorous content of the glass core decreases, with glass cores that contain no phosphorous exhibiting the least amount of induced spectral attenuation at high temperature and pressure.

The invention may be embodied in other specific forms without departing from the spirit or essential characteristics thereof. The foregoing embodiments are therefore to be considered in all respects illustrative rather than limiting on the invention described herein. Scope of the invention is thus indicated by the appended claims rather than by the foregoing description, and all changes that come within the meaning and range of equivalency of the claims are intended to be embraced therein.

1. An optical fiber, comprising:
a glass fiber comprising a glass core and a cladding; and
a hermetic layer disposed on the cladding,
wherein the glass core comprises no more than about 1 mole % phosphorous.

2. The optical fiber of claim 1, wherein the glass core comprises about 0 mole % phosphorous.

3. The optical fiber of claim 1, wherein the cladding comprises no more than about 1 mole % phosphorous.

4. The optical fiber of claim 3, wherein the cladding comprises about 0 mole % phosphorous.

5. The optical fiber of claim 1, wherein a portion of the cladding comprises more than about 1 mole % phosphorous.

6. The optical fiber of claim 1, wherein the hermetic layer comprises a material selected from the group consisting of ceramics, metals, carbon, and combinations thereof.

7. The optical fiber of claim 6, wherein the hermetic layer comprises carbon.

8. The optical fiber of claim 1, wherein the glass core comprises silica doped with germanium.

9. The optical fiber of claim 1, further comprising an at least one outer layer disposed on the hermetic layer.

10. The optical fiber of claim 9, wherein the at least one outer layer comprises a polymer.

11. The optical fiber of claim 10, wherein the polymer is selected from the group consisting of acrylate polymers, fluorinated polymers, phenolic polymers, and polyimide polymers.

12. The optical fiber of claim 9, wherein the at least one outer layer comprises a metal.

13. The optical fiber of claim 12, wherein the metal is selected from the group consisting of aluminum, gold, nickel, tin, and alloys thereof.

14. A method of making an optical fiber, the method comprising the step of:
applying a hermetic onto a glass fiber,
wherein the glass fiber comprises a glass core and a cladding, and the glass core comprises no more than about 1 mole % phosphorous.

15. The method of claim 14, wherein the glass fiber comprises about 0 mole % phosphorous.

16. The method of claim 14, wherein the cladding comprises no more than about 1 mole % phosphorous.

17. The method of claim 16, wherein the cladding comprises about 0 mole % phosphorous.

18. The method of claim 14, wherein a portion of the cladding comprises more than about 1 mole % phosphorous.

19. The method of claim 14, wherein the hermetic layer comprises a material selected from the group consisting of ceramics, metals, carbon, and combinations thereof.

20. The method of claim 19, wherein the hermetic layer comprises carbon.

21. The method of claim 14, wherein the glass core comprises silica doped with germanium.

22. The method of claim 14, further comprising disposing an at least one outer layer on the hermetic layer.

23. The method of claim 22, wherein the at least one outer layer comprises a polymer.

24. The method of claim 23, wherein the polymer is selected from the group consisting of acrylate polymers, fluorinated polymers, phenolic polymers, and polyimide polymers.

25. The method of claim 22, wherein the outer layer comprises a metal.

26. The optical fiber of claim 25, wherein the metal is selected from the group consisting of aluminum, gold, nickel, tin, and alloys thereof.

27. A method of transmitting radiation in a harsh environment, the method comprising the steps of:
providing an optical fiber comprising a glass core and a cladding, wherein the glass core comprises no more than about 1 mole % phosphorous, and a hermetic layer over the cladding;
deploying the optical fiber in a hydrogen-containing environment having a temperature in excess of 100° C.; and
transmitting radiation through the optical fiber.

28. The method of claim 27, wherein the environment has a temperature in excess of 200° C.

29. The method of claim 27, wherein the glass core comprises about 0 mole % phosphorous.

30. The method of claim 27, wherein the cladding comprises no more than about 1 mole % phosphorous.

31. The method of claim 30, wherein the cladding comprises about 0 mole % phosphorous.

32. The method of claim 27, wherein a portion of the cladding comprises more than about 1 mole % phosphorous.

33. The method of claim 27, wherein the hermetic layer comprises a material selected from the group consisting of ceramics, metals, carbon, and combinations thereof.

34. The method of claim 33, wherein the hermetic layer comprises carbon.

35. The method of claim 27, wherein the glass core comprises silica doped with germanium.

36. The method of claim 27, further comprising an at least one outer layer disposed on the hermetic layer.

37. The method of claim 36, wherein the at least one outer layer comprises a polymer.

38. The method of claim 37, wherein the polymer is selected from the group consisting of acrylate polymers, fluorinated polymers, phenolic polymers, and polyimide polymers.

39. The method of claim 36, wherein the at least one outer layer comprises a metal.

40. The method of claim 39, wherein the metal is selected from the group consisting of aluminum, gold, nickel, tin, and alloys thereof.
